(19) United States
(12) Patent Application Publication
(10) Pub. No.: US 2026/0017178 A1
(43) Pub. Date: Jan. 15, 2026

(54) METHOD AND SYSTEM FOR DETERMINING REFERENCE TO DYNAMIC VALUES FOR PERFORMING LOAD TESTING

(71) Applicant: HCL Technologies Limited, New Delhi (IN)

(72) Inventor: Arun Narayanan Kutty, Cary, NC (US)

(21) Appl. No.: 19/169,095

(22) Filed: Apr. 3, 2025

(30) Foreign Application Priority Data
Jul. 9, 2024 (IN) 202411052355

(51) Int. Cl. G06F 11/3668; G06F 40/284

(52) U.S. Cl. CPC G06F 11/3684; G06F 40/284

(57) ABSTRACT

A method and system of determining reference to dynamic values is disclosed. A processor receives at least one testing scenario for load testing an application. At least one load testing script is determined based on the at least one load testing scenario. A natural language prompt is received from a user for identifying the reference to the at least one dynamic value within the at least one load testing script. The at least one load testing script and the natural language prompt is tokenized to generate a tokenized load testing script and a tokenized prompt. An LLM is prompted using the tokenized prompt to determine at least one tokenized reference corresponding to at least one tokenized dynamic value from the tokenized load testing script. The at least one tokenized reference is de-tokenized to determine an LLM determined reference to the at least one dynamic value.

### TECHNICAL FIELD

This disclosure relates generally to load testing of an application, and more particularly to method and system for determining reference to dynamic values for performing load testing.

### BACKGROUND

In the field of application development, such as web applications and software applications, it is crucial for application developers to make sure that their applications operate at their best when there are varying user loads. Developers developing applications, such as e-commerce platforms or online ticket booking systems, must perform comprehensive load testing before their applications go live. This testing ensures that the application can handle numerous concurrent user interactions and transactions efficiently. Given the complexity and volume of these interactions, manual testing is impractical and necessitates the use of specialized load testing tools.

Effective load testing requires simulating real-world user scenarios, which involves numerous dynamic values such as user credentials, session identifiers, and transaction-specific details. Accurately identifying and substituting these dynamic parameters is crucial for realistic load testing. Current methods involve manual intervention to identify these dynamic values by manually determining reference to these dynamic values which leads to a tedious and error-prone process. This complexity hinders the efficiency and reliability of load testing practices.

Therefore, there is a need for an efficient methodology of determining reference to dynamic values for performing load testing.

### SUMMARY OF THE INVENTION

In an embodiment, a method of determining reference to dynamic values for performing load testing is disclosed. The method may include receiving, by a processor, at least one testing scenario for load testing an application. The method may further include determining, by the processor, at least one load testing script based on the at least one load testing scenario. In an embodiment, the at least one testing script may simulate the at least one load testing scenario for performing the load testing. In an embodiment, the at least one load testing script may include at least one dynamic value and a reference to the at least one dynamic value. The method may further include receiving, by the processor, a natural language prompt from a user for identifying the at least one dynamic value within the at least one load testing script. The method may further include tokenizing, by the processor, the at least one load testing script and the natural language prompt using a tokenizer to generate a tokenized load testing script and a tokenized prompt. The method may further include prompting, by the processor, a Large Language Model (LLM) using the tokenized prompt to determine at least one tokenized reference corresponding to at least one tokenized dynamic value from the tokenized load testing script. The method may further include de-tokenizing, by the processor, the at least one tokenized reference corresponding to the at least one tokenized dynamic value to determine an LLM determined reference to the at least one dynamic value.

In another embodiment, a system for determining reference to dynamic values for performing load testing is disclosed. The system may include a processor and a memory communicably coupled to the processor, wherein the memory stores processor-executable instructions, which when executed by the processor, cause the processor to receive at least one testing scenario for load testing an application. The processor may be further configured to determine at least one load testing script based on the at least one load testing scenario. In an embodiment, the at least one testing script may simulate the at least one load testing scenario for performing the load testing. In an embodiment, the at least one load testing script may include at least one load dynamic value and a reference to the at least one dynamic value. The processor may be further configured to receive a natural language prompt from a user for identifying the at least one dynamic value within the at least one load testing script. The processor may be further configured to tokenize the at least one load testing script and the natural language prompt using a tokenizer to generate a tokenized load testing script and a tokenized prompt. The processor may be further configured to prompt a Large Language Model (LLM) using the tokenized prompt to determine at least one tokenized reference corresponding to at least one tokenized dynamic value corresponding to the at least one dynamic value from the tokenized load testing script. The processor may be further configured to de-tokenize the at least one tokenized reference corresponding to the at least one tokenized dynamic value to determine an LLM determined reference to the at least one dynamic value.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for determining reference to dynamic values for performing load testing, in accordance with an embodiment of the present disclosure.

FIG. 2 is a functional block diagram of a computing device of the exemplary system of FIG. 1, in accordance with an embodiment of the present disclosure.

FIG. 3 illustrates a graphical user interface (GUI) of an application for performing load testing enabled on the computing device, in accordance with an embodiment of the present disclosure.

FIG. 4 illustrates a reference interface displaying the properties of the at least one reference, in accordance with an embodiment of the present disclosure.

FIG. 5 illustrates a pop-up interface, in accordance with an embodiment of the present disclosure.

FIG. 6 illustrates a response user interface to display large language model (LLM) determined reference to the at least one dynamic value, in accordance with an embodiment of the present disclosure.

FIG. 7 illustrates a flowchart of a method of determining reference to dynamic values for performing load testing, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

Typically load testing systems generate testing scripts that capture the sequential request-response pairs between clients and servers. These testing scripts are then used to simulate user interactions under load conditions. Typically load testing systems offer features for identifying dynamic parameters and substituting them during simulation.

Despite advancements in testing automations, conventional load testing tools still fall short in several areas like it requires manual effort, especially when dealing with non-standard data formats or complex application logic to define reference to dynamic values for extracting dynamic values demands advanced programming skills and logical thinking. This necessity often results in increased time and effort, particularly for less experienced users. The trial-and-error nature of manual determination of the reference to dynamic values can lead to inefficiencies which makes the load testing process more time-consuming and less reliable.

Accordingly, the present disclosure provides a method and system for determining reference to dynamic values for performing load testing.

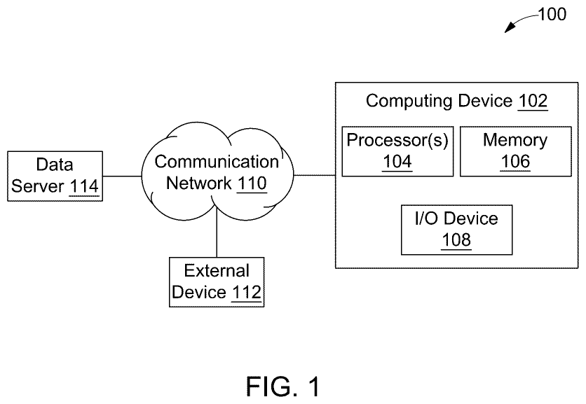

Referring now to FIG. 1, a block diagram of an exemplary system 100 for determining reference to dynamic values for performing load testing is illustrated, in accordance with an embodiment of the current disclosure. The system 100 may include a computing device 102, an external device 112, and a data server 114 communicably coupled to each other through a wired or wireless communication network 110. The computing device 102 may include a processor 104, a memory 106, and an input/output (I/O) device 108.

In an embodiment, examples of processor(s) 104 may include but are not limited to, an Intel® Itanium® or Itanium 2 processor(s), or AMD® Opteron™ or Athlon MP® processor(s), Motorola® lines of processors, Nvidia®, FortiSOC™ system on a chip processors or other future processors.

In an embodiment, the memory 106 may store instructions that, when executed by the processor 104, and cause the processor 104 to determine reference to dynamic values for performing load testing, as will be discussed in greater details herein below. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the I/O device 108 may comprise of variety of interface(s), for example, interfaces for data input and output devices, and the like. The I/O device 108 may facilitate inputting of instructions by a user communicating with the computing device 102. In an embodiment, the I/O device 108 may be wirelessly connected to the computing device 102 through wireless network interfaces such as Bluetooth®, infrared, or any other wireless radio communication known in the art. In an embodiment, the I/O device 108 may be connected to a communication pathway for one or more components of the computing device 102 to facilitate the transmission of inputted instructions and output results of data generated by various components such as, but not limited to, processor(s) 104 and memory 106.

In an embodiment, the data server 114 may be enabled in a remote cloud server or a co-located server and may include a database to store an application, a large language model (LLM) and other data necessary for the system 100 to perform load testing. In an embodiment, the data server 114 may store data input by an external device 112 (e.g., prompts) or output generated by the computing device 102 (e.g., reference to dynamic values). It is to be noted that the application may be designed and implemented as either a web application or a software application. The web application may be developed using a variety of technologies such as HTML, CSS, JavaScript, and various web frameworks like React, Angular, or Vue.js. It may be hosted on a web server and accessible through standard web browsers. On the other hand, the software application may be a standalone program installed on users' devices, which may be developed using programming languages such as Java, C++, Python, or any other suitable language depending on the platform. In an embodiment, the computing device 102 may be communicably coupled with the data server 114 through the communication network 110.

In an embodiment, the communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the communication network 110 can include a variety of network devices, including routers, bridges, servers, computing devices, storage devices, and the like.

In an embodiment, the computing device 102 may receive a user input for determining reference to dynamic values for performing load testing from an external device 112 through the communication network 110. In an embodiment, the computing device 102 and the external device 112 may be a computing system, including but not limited to, a smart phone, a laptop computer, a desktop computer, a notebook, a workstation, a server, a portable computer, a handheld, or a mobile device. In an embodiment, the computing device 102 may be, but not limited to, in-built into the external device 112 or may be a standalone computing device.

In an embodiment, the computing device 102 may perform various processing in order to determine reference to dynamic values for performing load testing. By way of an example, the computing device 102 may receive at least one testing scenario for load testing the application. It should be noted that the application may be indicated or provided by a user via the I/O device 108. For example, the user may indicate a file path for the application. In an embodiment, the application may undergo load testing to ensure its performance under various conditions. One example of the at least one testing scenario may include simulating a high number of concurrent users accessing the application simultaneously.

The computing device 102 may further determine at least one load testing script based on the at least one load testing scenario. In an embodiment, the at least one testing script may simulate the at least one load testing scenario for performing the load testing. In an embodiment, the at least one load testing script may include at least one dynamic value and a reference to the at least one dynamic value. In an embodiment, the at least one load testing script may include sensitive information. In an embodiment, the at least one dynamic value may be a variable element in the load testing script 300 that may change with each instance of execution or based on change in user session. It is to be noted that the reference to the at least one dynamic value may include a regular expression or a path-based expression, etc.

The computing device 102 may further receive a natural language prompt from a user for identifying the at least one dynamic value within the at least one load testing script. In an embodiment, the natural language prompt may be received via the I/O device 108. The computing device 102 may further tokenize the at least one load testing script and the natural language prompt using a tokenizer to generate a tokenized load testing script and a tokenized prompt. In an embodiment, the tokenizer may utilize a known in the art and a pre-trained tokenizer and de-tokenizer model. Further, the tokenization of the at least one load testing script may include masking the sensitive information. The computing device 102 may further prompt the large language model (LLM) using the tokenized prompt to determine at least one tokenized reference corresponding to at least one tokenized dynamic value corresponding to the at least one dynamic value from the tokenized load testing script. Examples of the LLM may include, but are not limited to, zephyr, code LLAMA, GPT, etc.

The computing device 102 may further de-tokenize the at least one tokenized reference corresponding to the at least one tokenized dynamic value to determine an LLM determined reference to the at least one dynamic value. In an embodiment, the de-tokenization may be performed using the known in the art pretrained tokenizer and de-tokenizer model. The computing device 102 may further validate the LLM determined reference corresponding to the at least one tokenized dynamic value based on a user feedback. In an embodiment, the user feedback may be received via the I/O device 108.

The computing device 102 may further update the reference to the at least one dynamic value based on the user feedback in case of a mismatch between the LLM determined reference and the user feedback. It is to be noted that the computing device 102 may fine-tune the LLM based on the user feedback.

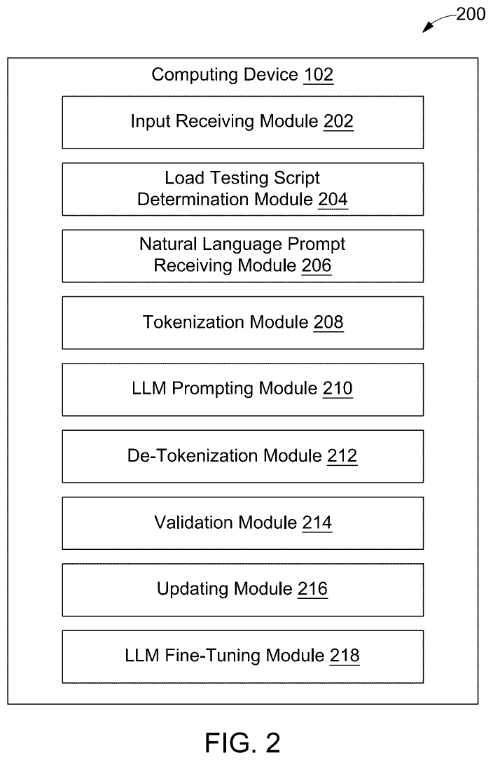

FIG. 2 illustrates a functional block diagram of the computing device 102, in accordance with an embodiment of the present disclosure. FIG. 2 is explained in conjunction with FIG. 1. In an embodiment, the computing device 102 may include an input receiving module 202, a load testing script determination module 204, a natural language prompt receiving module 206, a tokenization module 208, an LLM prompting module 210, a de-tokenization module 212, a validation module 214, an updating module 216 and an LLM fine-tuning module 218.

The input receiving module 202 may receive at least one testing scenario for load testing an application. In an embodiment, the application may be designed and implemented as either a web application or a software application. The web application may be developed using a variety of technologies such as, but not limited to, HTML, CSS, JavaScript, and various web frameworks such as, but not limited to, React, Angular, or Vue.js. It may be hosted on a web server and accessible through standard web browsers. On the other hand, the software application may be a standalone program installed on user devices, which may be developed using programming languages such as, but not limited to, Java, C++, Python, or any other suitable language depending on the platform. It should be noted that the application may be accessed by a user for performing load testing via the I/O device 108. For example, the user may indicate a file path or a web path for accessing the web application.

In an embodiment, load testing of the application may be performed to ensure its performance under various load conditions. One example of the at least one testing scenario may include simulating a high number of concurrent users accessing the application simultaneously. In an exemplary embodiment, for a web application developed, the input receiving module 202 may receive a testing scenario for simulating a plurality of concurrent users accessing a webpage of the web application.

The load testing script determination module 204 may determine at least one load testing script based on the at least one load testing scenario. In an embodiment, the at least one testing script may simulate the at least one load testing scenario for performing the load testing. In an embodiment, various testing scripts may be simulated individually for each of a plurality of load testing scenarios. It is to be noted that the at least one load testing script may include at least one dynamic value and a reference to the at least one dynamic value. The at least one dynamic value and the reference to the at least one dynamic value may enable the load testing scenario for performing load testing. It is to be noted that the reference to the at least one dynamic value may include a regular expression or a path-based expression. In accordance with the exemplary embodiment, the load testing script determination module 204 may further generate a load testing script that may include dynamic values such as session IDs, or user tokens, which are referenced using regular expressions or path-based expressions. It is to be noted that load testing scripts may include very lengthy code that may run for several pages. Thus, manual determination of references to the dynamic values becomes a very tedious task. Further, manual determination may be prone to errors. Thus, the current disclosure provides integration of an LLM with the testing application to determine the reference to the dynamic values.

Thus, the natural language prompt receiving module 206 may receive a natural language prompt from a user for identifying the at least one dynamic value within the at least one load testing script. In accordance with the exemplary embodiment, the natural language prompt receiving module 206 may receive a prompt such as “Identify references to all session IDs in the load testing script” to locate dynamic values related to user sessions in the load testing script.

It is to be noted that the at least one load testing script may include sensitive and proprietary information, therefore it may be desired to prevent such information from being disclosed to the LLM server. Thus, the tokenization module 208 may tokenize the at least one load testing script and the natural language prompt using a tokenizer model to generate a tokenized load testing script and a tokenized prompt. Further, the tokenization of the at least one load testing script may include masking the sensitive information. In an embodiment, the sensitive information may include financial data such as, but not limited to, credit card number, etc. Further, sensitive information may include ID information such as, but not limited to, social security number, passport number, etc. In accordance with the exemplary embodiment, the tokenization module 208 may tokenize the script and the prompt to ensure that any sensitive information within the script is masked during the tokenization process. Thus, the tokenization of the load testing script and the natural language prompt may enhance security and privacy of the sensitive information during interactions with the LLM.

The LLM prompting module 210 may prompt a large language model (LLM) using the tokenized prompt to determine at least one tokenized reference corresponding to at least one tokenized dynamic value corresponding to the at least one dynamic value from the tokenized load testing script. In an embodiment, examples of the LLM may include, but are not limited to, zephyr, code LLAMA, GPT, etc. In accordance with the exemplary embodiment, given the tokenized prompt about session IDs, the LLM prompting module 210 may output tokenized references indicating references of session IDs and other dynamic values in the tokenized load testing script.

The de-tokenization module 212 may de-tokenize the at least one tokenized reference corresponding to the at least one tokenized dynamic value to determine an LLM determined reference to the at least one dynamic value. In accordance with the exemplary embodiment, the de-tokenization module 212 may convert the tokenized references back into human-readable form to identify references to these session IDs or other dynamic values in the load testing script based on the output of the LLM. In an embodiment, the de-tokenization may be done using a known in the art pretrained de-tokenizer model.

The validation module 214 may validate the LLM determined reference corresponding to the at least one tokenized dynamic value based on a user feedback. In accordance with the exemplary embodiment, the LLM determined reference to the dynamic values may be displayed by highlighting each of the LLM determined reference in the load testing script to the user via a display of the I/O device 108. Accordingly, the user may check or verify the LLM determined reference by scanning through the load testing script. Further, the user may provide a user feedback by indicating or selecting the reference in the testing script in case not identified by the LLM using the I/O device 108. Thus, the user feedback may confirm or correct the reference identification by the LLM.

The updating module 216 may update the reference to the at least one dynamic value based on the user feedback in case of a mismatch between the LLM determined reference and the user feedback. In accordance with the exemplary embodiment, if the user corrects the LLM determined reference to the dynamic value by providing user feedback, the updating module 216 may update the script to reflect the reference as per the user feedback.

The LLM fine-tuning module 218 may further fine-tune the LLM based on the user feedback. In accordance with the exemplary embodiment, user feedback may be used to fine-tune the LLM for identifying the reference to dynamic values within load testing scripts to enhance the accuracy and reliability of the LLM.

It should be noted that all such aforementioned modules 202-218 may be represented as a single module or a combination of different modules. Further, as will be appreciated by those skilled in the art, each of the modules 202-218 may reside, in whole or in parts, on one device or multiple devices in communication with each other. In some embodiments, each of the modules 202-218 may be implemented as dedicated hardware circuit comprising custom application-specific integrated circuit (ASIC) or gate arrays, off-the-shelf semiconductors such as logic chips, transistors, or other discrete components. Each of the modules 202-218 may also be implemented in a programmable hardware device such as a field programmable gate array (FPGA), programmable array logic, programmable logic device, and so forth. Alternatively, each of the modules 202-218 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for optimizing resource utilization in cloud-based data processing platforms. For example, the exemplary system 100 and the associated processor 102 may determine reference to dynamic values for performing load testing by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

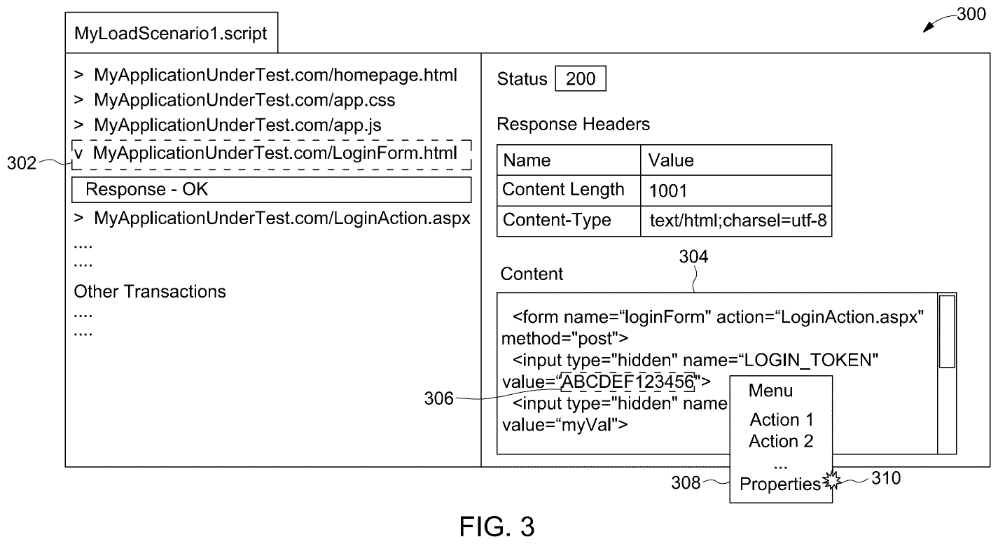

Referring now to FIG. 3, a graphical user interface (GUI) 300 of an application for performing load testing enabled on the computing device 102 is illustrated, in accordance with an embodiment of the present disclosure. FIG. 3 is explained in conjunction with FIGS. 1 and 2. The GUI 300 is designed to interact with the load testing application installed on the computing device 102 enabled for performing load testing. The GUI 300 as shown in FIG. 3, depicts a testing scenario display area 302, a testing script display area 304, a dynamic value display area 306, a menu display area 308, and a properties display area 310.

The testing scenario display area 302 depicts the at least one testing scenario for performing load testing of a web application. The testing scenario display area 302 may be designed to display the at least one testing scenario recorded based on access of the web application via the network 110. The testing scenario display area 302 may list one or more testing scenarios and may allow the user to select one of the listed testing scenarios to view its testing script in the testing script display area 304. The testing script displayed in the testing script display are 304 may be used for performing load testing by simulation of the load testing scenario. In an exemplary embodiment, the load testing script may be configured to simulate a plurality of concurrent users accessing the homepage of the web application, for performing the load testing using a load testing scenario.

Further, in order to perform load testing reference to the dynamic values in the testing script may be determined. Accordingly, the dynamic values present in the testing script displayed in the testing script display area 304 may be selected by the user and displayed in the value display area 306. In accordance with the exemplary embodiment, the at least one dynamic value may be a variable value within the load testing script that may change with each execution of the test script when simulating multiple user sessions. In an embodiment, the at least one dynamic value may be, but not limited to, a login token, an IP address, which varies for each user session to simulate real-world conditions more accurately.

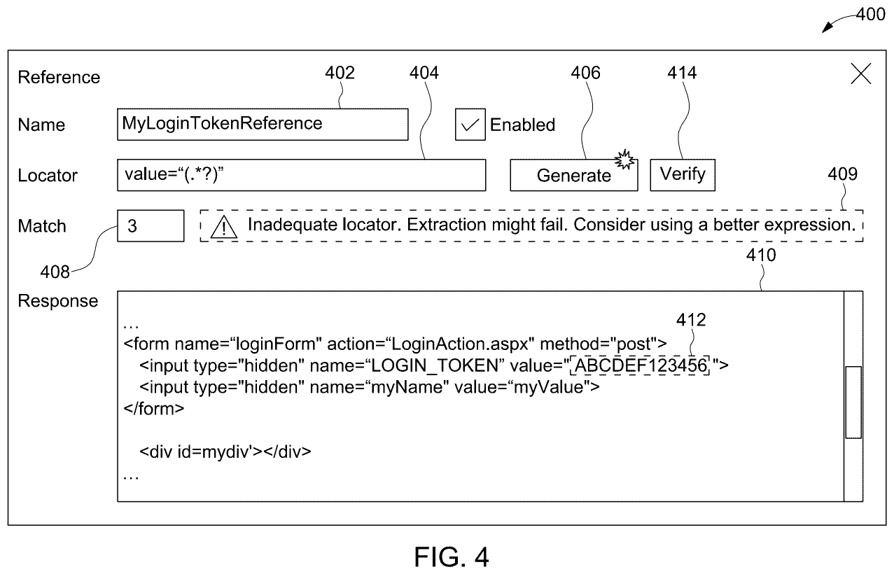

Further, the menu display area 308 may allow the users to select from a plurality of functionalities, such as, but not limited to, viewing properties of the at least one dynamic value as displayed in the value display area 306 by selecting a properties button interface 310. Further, selection of the properties button interface 310 displays a reference interface 400 as shown in FIG. 4.

Referring now to FIG. 4, a reference interface 400 displaying the properties of the at least one reference is illustrated, in accordance with an embodiment of the present disclosure. FIG. 4 is explained in conjunction with FIGS. 1-3. In an embodiment, the reference interface 400 may be enabled as a GUI and may include a name display area 402, a locator display area 404, a verify button 406, a match display area 408, a response display area 410, a dynamic value locator area 412, and a generate button 414.

The name display area 402 may display a name corresponding to the reference to the at least one dynamic value. The name of the reference may be displayed based on determination of the reference by the LLM or as selected by the user when providing user feedback. The name display area 402 helps users identify and manage the at least one dynamic value by their names. As shown in FIG. 4, an example of the name corresponding to reference to the at least one dynamic value is depicted as ‘MyLoginTokenReference’.

As depicted in FIG. 4, the locator display area 404 may depict a default reference to the at least one dynamic value. Users can input this default reference, which serves as a starting point for identifying the at least one dynamic value within load testing scripts. As shown in FIG. 4, the default reference to the at least one dynamic value for ‘MyLoginTokenReference’ is depicted as “value=“(, *?)”’.

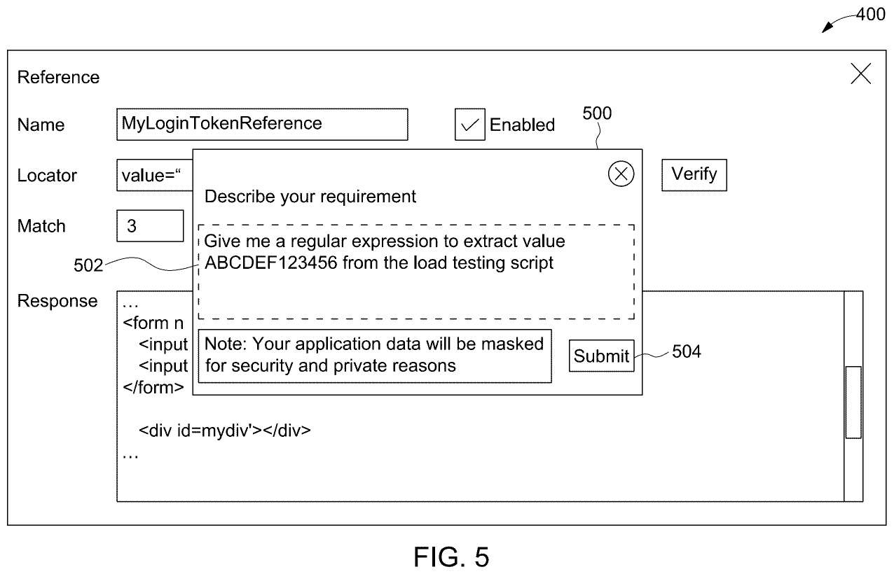

Further, the generate button 406 may be used to determine reference to the at least one dynamic value using an LLM. In an embodiment, on selection of the generate button 406, a pop-up user interface 500 may be displayed on top of the reference interface 400 as shown in FIG. 5.

Referring now to FIG. 5, the pop-up user interface 500 is illustrated, in accordance with an embodiment of the present disclosure. FIG. 5 is explained in conjunction with FIGS. 1-4. In an embodiment, the pop-up user interface 500 may be enabled as a GUI and may include a prompt area 502 and a submit button 504.

The prompt area 502 may allow the user to input a natural language prompt for the LLM to identify the at least one dynamic value within the at least one load testing script displayed in the testing script display area 304 of FIG. 3. In an embodiment, the user may input a prompt by specifying a dynamic value corresponding to which the reference is to be determined in the load testing script. For example, “Give me a regular expression to extract dynamic value “ABCDEF123456” from the load testing script”. Further, the submit button 504 allows the user to input the natural language prompt that may then be tokenized to generate a tokenized prompt. Further, on selection of the submit button 504, the load testing script may also be tokenized to generate a tokenized load test script. Both the tokenized prompt and the tokenized load testing script may be inputted to the LLM for the LLM to process the information without revealing proprietary and sensitive information.

It should be noted that LLM may be accessible via the application for performing load testing via the network 110. In an embodiment, the LLM may be pretrained or fine-tuned for determining reference to the dynamic values in the load testing script. It is to be noted that in order to prevent the transmission of proprietary and sensitive information to the LLM the load testing script and the natural language prompt input by the user may be tokenized. In an embodiment, the at least one load testing script and the natural language prompt may be tokenized using a tokenizer model to generate a tokenized load testing script and a tokenized prompt. Further, the tokenization of the at least one load testing script may include masking the sensitive information. According to an example, the tokenized load testing script may be represented as “<****MASKED****”>” and the tokenized prompt may be represented as “Gi**me a re***r e*******n to e****t d*******c v***e**************6 f***t**1***t*****s****”.

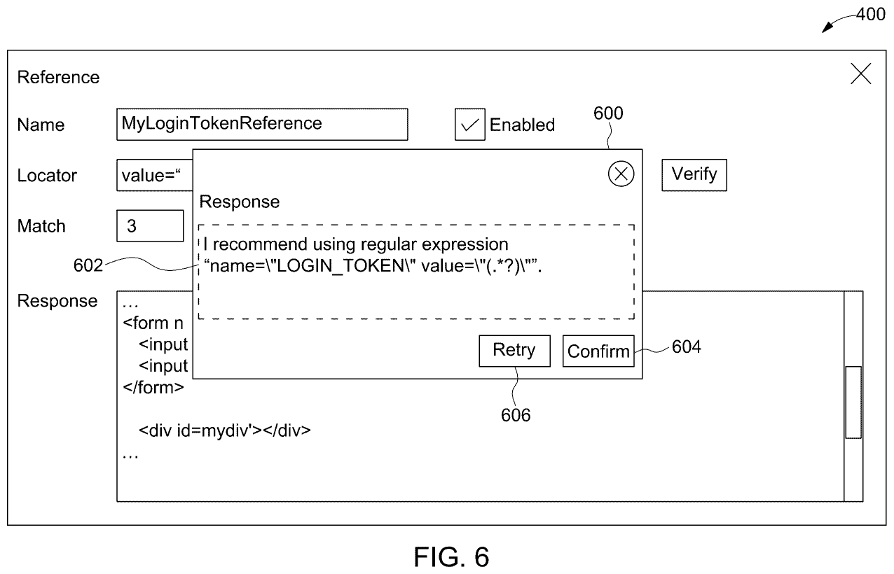

Accordingly, the LLM may process the tokenized prompt to determine at least one tokenized reference corresponding to at least one tokenized dynamic value in the tokenized load testing script. For example, the at least one tokenized reference to the at least one tokenized dynamic value may be identified as ‘name=***TOKENIZED***’. Further, the at least one tokenized reference corresponding to the at least one tokenized dynamic value may be de-tokenized upon receiving by the computing device 102 from the LLM to determine an LLM determined reference to the at least one dynamic value. In an embodiment, the LLM determined reference to the at least one dynamic value may be displayed on a pop-up response user interface 600 that may be displayed on top of the reference interface 400 as shown in FIG. 6. It is to be noted that the response user interface 600 may replace the pop-up user interface 500.

Referring now to FIG. 6, the response user interface 600 to display the LLM determined reference to the at least one dynamic value is illustrated, in accordance with an embodiment of the present disclosure. FIG. 6 is explained in conjunction with FIGS. 1-5. In an embodiment, the response user interface 600 may be enabled as a GUI and may include a reference display area 602, a confirm button 604, and a retry button 606.

The reference display area 602 may display the LLM determined reference to the at least one dynamic value. For example, the response received from the LLM as shown in FIG. 6 includes an LLM determined reference to the dynamic value “ABCDEF123456” as “name=\“LOGIN_TOKEN\”(.*?) \”.

Further, the confirm button 604 allows the user to confirm the LLM determined reference to the at least one dynamic value as output and displayed in the reference display area 602.

Further, the retry button 606 may allow the user to request the LLM to again determine the reference to the at least one dynamic value. Upon clicking the retry button 606, the LLM may again process the tokenized prompt to determine a tokenized reference to the tokenized dynamic value in the tokenized load testing script. Accordingly, the LLM may again output a tokenized reference to the tokenized dynamic value. Further, the tokenized reference may be de-tokenized and displayed on the reference display area 602.

In another embodiment, the user may accept the LLM determined reference by clicking or selecting the confirm button 604 and further proceed to validating the LLM determined reference.

Referring back to FIG. 4, the reference to the at least one dynamic value determined by the LLM may be further validated by selecting the verify button 406. Upon selection of the verify button 406, the response user interface 600 may close and the user may be enabled to verify the accuracy of the LLM determined reference to the at least one dynamic value in the reference interface 400.

Further, the match display area 408 depicts a number of instances of occurrence of the reference to the at least one dynamic value in the load testing script displayed in the response display area 410. Based on the number of instances displayed in the match display area 408, a feedback message 409 may be displayed indicating whether the LLM determined reference is adequate or if adjustments are needed in the reference expression determined by the LLM.

Further, the response display area 410 may allow the user to view the LLM determined reference occurring in the response display area 410 by selecting the verify button 414. The user may manually verify if the corresponding dynamic reference value is referred to by using the LLM determined reference. In case the user determines a mismatch between the LLM determined reference and the actual reference, the user may input the input the correct reference in the locator window 404 and select the verify button 414. Further, on selection of the verify button 414, the reference input by the user may be recorded as a user feedback. Further, based on the user feedback the match display area 408 may be updated to depict an updated number of instances of occurrence of the reference to the at least one dynamic value in the load testing script that may match with the user provided reference input. Further, the feedback message 409 may also be updated based on the verification.

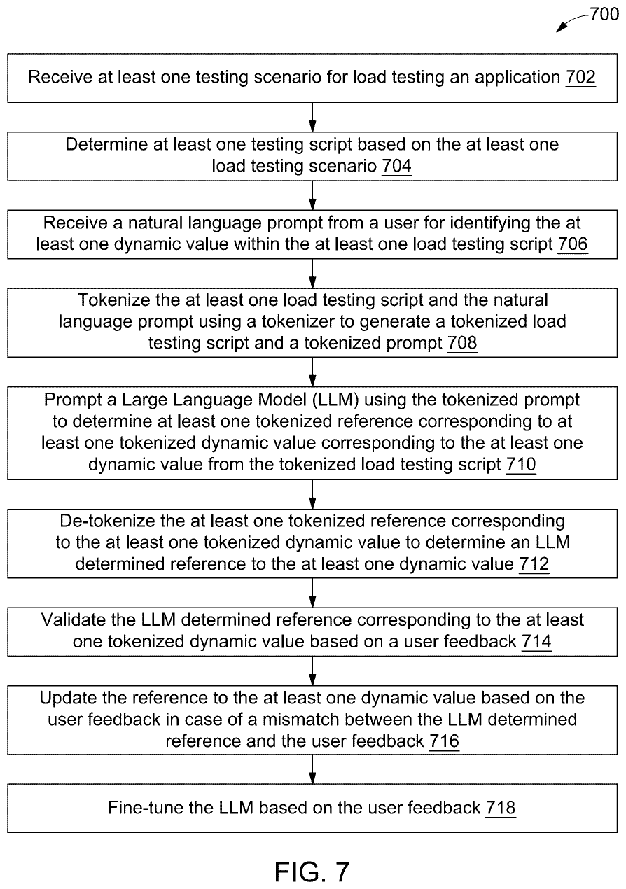

Referring now to FIG. 7, a flowchart 700 of a method of determining reference to the at least one dynamic value for performing load testing is illustrated, in accordance with an embodiment of the present disclosure. FIG. 7 is explained in conjunction with FIGS. 1 and 2. In an embodiment, the method may include a plurality of steps. Each step of the flowchart 700 may be executed by various modules, same as the modules of the computing device 102 so as to determine reference to the at least one dynamic value.

At step 702, the computing device 102 may receive at least one testing scenario for load testing an application. In an embodiment, the application may be designed and implemented as either a web application or a software application. It should be noted that the application may be indicated or provided by a user via the I/O device 108. For example, the user may indicate a file path or a web path for accessing the application. In an embodiment, load testing of the application may be performed to ensure its performance under various load conditions. One example of the at least one testing scenario may include simulating a high number of concurrent users accessing the application simultaneously.

Further, at step 704, the computing device 102 may further determine at least one load testing script based on the at least one load testing scenario. In an embodiment, the at least one testing script may simulate the at least one load testing scenario for performing the load testing. In an embodiment, various testing scripts may be simulated individually for each of a plurality of load testing scenarios. It is to be noted that, the at least one load testing script may include at least one dynamic value and a reference to the at least one dynamic value. The at least one dynamic value and the reference to the at least one dynamic value may be determined to enable the load testing scenario for performing load testing. It is to be noted that, the reference to the at least one dynamic value may include a regular expression or a path-based expression. In order to determine the references to the dynamic values automatically, an LLM may be utilized.

Thus, at step 706, the computing device 102 may receive a natural language prompt from a user for identifying the at least one dynamic value within the at least one load testing script. In an embodiment, the natural language prompt may be received via the I/O device 108.

It is to be noted that the at least one load testing script may include sensitive information and proprietary information, therefore it may be desired to prevent such information from being disclosed to the LLM server. Therefore, at step 708, the computing device 102 may further tokenize the at least one load testing script and the natural language prompt using a tokenizer model to generate a tokenized load testing script and a tokenized prompt. Further, the tokenizer may utilize a known in the art and a pre-trained tokenizer and de-tokenizer model. Further, the tokenization of the at least one load testing script may include masking the sensitive information. In an embodiment, the sensitive information may include financial data such as, but not limited to, credit card number, etc. Further, sensitive information may include ID information such as, but not limited to, social security number, passport number, etc. Thus, the tokenization of the load testing script and the natural language prompt may ensure security and privacy during the load testing.

Further, at step 710, the computing device 102 may further prompt a large language model (LLM) using the tokenized prompt to determine at least one tokenized reference corresponding to at least one tokenized dynamic value. It is to be noted that the tokenized dynamic value may correspond to the at least one dynamic value from the tokenized load testing script. Examples of the LLM may include, but are not limited to, zephyr, code LLAMA, GPT, etc. Further, at step 712, the computing device 102 may further de-tokenize the at least one tokenized reference corresponding to the at least one tokenized dynamic value to determine an LLM determined reference to the at least one dynamic value. In an embodiment, the de-tokenization may be performed using the known in the art pretrained tokenizer and de-tokenizer model.

Further, at step 714, the computing device 102 may further validate the LLM determined reference corresponding to the at least one tokenized dynamic value based on a user feedback. In an embodiment, the user feedback may be received via the I/O device 108. Further, the user may provide a user feedback by indicating or selecting the reference in the testing script in case not identified by the LLM using the I/O device 108. Further, at step 716, the computing device 102 may further update the reference to the at least one dynamic value based on the user feedback in case of a mismatch between the LLM determined reference and the user feedback. Further, at step 718, the computing device 102 may further fine-tune the LLM based on the user feedback.

Thus, the disclosed method and system try to overcome the technical problem of determining reference to dynamic values for performing load testing. In an embodiment, advantages of the disclosed method and system may include but is not limited to enhanced accuracy in identifying reference to the dynamic values, improved efficiency through automation, tokenization for enhanced security and privacy, adaptability and flexibility, and continuous improvement through feedback.

The disclosed method and system utilize a Large Language Model (LLM) to accurately identify references to dynamic values within load testing scripts. This reduces the likelihood of errors and increases the precision of load testing.

The disclosed method and system significantly reduce the manual effort required by automating the identification and referencing of dynamic values which leads to faster preparation and execution of load testing.

The disclosed method and system include tokenizing the load testing scripts and natural language prompts, which can mask sensitive information which enhances and ensures security and privacy of the sensitive information during interactions with the LLM.

As will be appreciated by those skilled in the art, the techniques described in the various embodiments discussed above are not routine, or conventional, or well-understood in the art. The techniques discussed above provide for determining reference to dynamic value for performing load testing.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described method and system for determining reference to dynamic values for performing load testing. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method of determining reference to dynamic values for performing load testing, the method comprising:
receiving, by a processor, at least one testing scenario for load testing an application;
determining, by the processor, at least one load testing script based on the at least one load testing scenario,
wherein the at least one testing script simulates the at least one load testing scenario for performing the load testing, and
wherein the at least one load testing script comprises at least one dynamic value and a reference to the at least one dynamic value;
receiving, by the processor, a natural language prompt from a user for identifying the at least one dynamic value within the at least one load testing script;
tokenizing, by the processor, the at least one load testing script and the natural language prompt using a tokenizer to generate a tokenized load testing script and a tokenized prompt;
prompting, by the processor, a Large Language Model (LLM) using the tokenized prompt to determine at least one tokenized reference corresponding to at least one tokenized dynamic value corresponding to the at least one dynamic value from the tokenized load testing script; and
de-tokenizing, by the processor, the at least one tokenized reference corresponding to the at least one tokenized dynamic value to determine an LLM determined reference to the at least one dynamic value.

2. The method of claim 1, wherein the at least one load testing script comprises sensitive information, and
wherein the tokenization of the at least one load testing script comprises masking the sensitive information.

3. The method of claim 1, wherein the reference to the at least one dynamic value comprises a regular expression or a path-based expression.

4. The method of claim 1, further comprising:
validating, by the processor, the LLM determined reference corresponding to the at least one tokenized dynamic value based on a user feedback.

5. The method of claim 4, further comprising:
updating, by the processor, the reference to the at least one dynamic value based on the user feedback in case of a mismatch between the LLM determined reference and the user feedback; and
fine-tuning, by the processor, the LLM based on the user feedback.

6. A system for determining reference to dynamic values for performing load testing, comprising:
a processor; and
a memory communicably coupled to the processor, wherein the memory stores processor-executable instructions, which when executed by the processor, cause the processor to:
receive at least one testing scenario for load testing an application;
determine at least one load testing script based on the at least one load testing scenario,
wherein the at least one testing script simulates the at least one load testing scenario for performing the load testing, and
wherein the at least one load testing script comprises at least one dynamic value and a reference to the at least one dynamic value;
receive a natural language prompt from a user for identifying the at least one dynamic value within the at least one load testing script;
tokenize the at least one load testing script and the natural language prompt using a tokenizer to generate a tokenized load testing script and a tokenized prompt;
prompt a Large Language Model (LLM) using the tokenized prompt to determine at least one tokenized reference corresponding to at least one tokenized dynamic value corresponding to the at least one dynamic value from the tokenized load testing script; and
de-tokenize the at least one tokenized reference corresponding to the at least one tokenized dynamic value to determine an LLM determined reference to the at least one dynamic value.

7. The system of claim 6, wherein the at least one load testing script comprises sensitive information, and
wherein the tokenization of the at least one load testing script comprises masking the sensitive information.

8. The system of claim 6, wherein the reference to the at least one dynamic value comprises a regular expression or a path-based expression.

9. The system of claim 6, wherein the processor-executable instructions cause the processor to:
validate the LLM determined reference corresponding to the at least one tokenized dynamic value based on a user feedback.

10. The system of claim 9, wherein the processor-executable instructions cause the processor to:
update the reference to the at least one dynamic value based on the user feedback in case of a mismatch between the LLM determined reference and the user feedback; and
fine-tune the LLM based on the user feedback.

11. A non-transitory computer-readable medium storing computer-executable instructions for determining references to dynamic values for performing load testing, the computer-executable instructions configured for:
receiving at least one testing scenario for load testing an application;
determining at least one load testing script based on the at least one load testing scenario,
wherein the at least one testing script simulates the at least one load testing scenario for performing the load testing, and
wherein the at least one load testing script comprises at least one dynamic value and a reference to the at least one dynamic value;
receiving a natural language prompt from a user for identifying the at least one dynamic value within the at least one load testing script;
tokenizing the at least one load testing script and the natural language prompt using a tokenizer to generate a tokenized load testing script and a tokenized prompt;
prompting a Large Language Model (LLM) using the tokenized prompt to determine at least one tokenized reference corresponding to at least one tokenized dynamic value corresponding to the at least one dynamic value from the tokenized load testing script; and
de-tokenizing the at least one tokenized reference corresponding to the at least one tokenized dynamic value to determine an LLM determined reference to the at least one dynamic value.

12. The non-transitory computer-readable medium of claim 11, wherein the at least one load testing script comprises sensitive information, and
wherein the tokenization of the at least one load testing script comprises masking the sensitive information.

13. The non-transitory computer-readable medium of claim 11, wherein the reference to the at least one dynamic value comprises a regular expression or a path-based expression.

14. The non-transitory computer-readable medium of claim 11, wherein the computer-executable instructions are configured for:
validating the LLM determined reference corresponding to the at least one tokenized dynamic value based on a user feedback.

15. The non-transitory computer-readable medium of claim 14, wherein the computer-executable instructions are configured for:
updating the reference to the at least one dynamic value based on the user feedback in case of a mismatch between the LLM determined reference and the user feedback; and
fine-tuning the LLM based on the user feedback.
